(19) United States
(12) Patent Application Publication
(10) Pub. No.: US 2007/0201308 A1
(43) Pub. Date: Aug. 30, 2007

(54) Decision Feedback Equalization in Mud-Pulse Telemetry

(75) Inventors: Ingolf Wassermann, Hannover (DE); Christian Klotz, Hannover (DE); Dang Hai Nguyen, Hannover (DE)

Correspondence Address: MADAN, MOSSMAN & SRIRAM, P.C., 2603 AUGUSTA, SUITE 700, HOUSTON, TX, 77057, US

(73) Assignee: BAKER HUGHES INCORPORATED, Houston, TX (US)

(21) Appl. No.: 11/674,866

(22) Filed: Feb. 14, 2007

Related U.S. Application Data
(60) Provisional application No. 60/773,364, filed on Feb. 14, 2006.

(51) Int. Cl. H04H 9/00

(52) U.S. Cl. 367/82; 340/854.3

(57) ABSTRACT

A decision feedback equalizer (DFE) structure which uses a reference signal based adaptive equalizer as forward filter and a blind adaptive equalizer as feedback filter is used for surface processing of mud pulse telemetry data.

### CROSS-REFERENCES TO RELATED APPLICATIONS

This application claims priority from U.S. Provisional patent application Ser. No. 60/773,364 filed on 14 Feb. 2006.

### BACKGROUND OF THE INVENTION

1. Field of the Invention

The present invention relates to telemetry systems for communicating information from a downhole location to a surface location, and, more particularly, to a method of removing inter symbol interference produced by reflections within the mechanical system, frequency selectivity of the sensors, the pulser and algorithms e.g. for noise cancellation

2. Description of the Related Art

Drilling fluid telemetry systems, generally referred to as mud pulse systems, are particularly adapted for telemetry of information from the bottom of a borehole to the surface of the earth during oil well drilling operations. The information telemetered often includes, but is not limited to, parameters of pressure, temperature, direction and deviation of the well bore. Other parameters include logging data such as resistivity of the various layers, sonic density, porosity, induction, self-potential and pressure gradients. This information is critical to efficiency in the drilling operation.

MWD Telemetry is required to link the downhole MWD components to the surface MWD components in real-time, and to handle most drilling related operations without breaking stride. The system to support this is quite complex, with both downhole and surface components that operate in step.

In any telemetry system there is a transmitter and a receiver. In MWD Telemetry the transmitter and receiver technologies are often different if information is being up-linked or down-linked. In up-linking, the transmitter is commonly referred to as the Mud-Pulser (or more simply the Pulser) and is an MWD tool in the BHA that can generate pressure fluctuations in the mud stream. The surface receiver system consists of sensors that measure the pressure fluctuations and/or flow fluctuations, and signal processing modules that interpret these measurements.

Down-linking is achieved by either periodically varying the flow-rate of the mud in the system or by periodically varying the rotation rate of the drillstring. In the first case, the flow rate is controlled using a bypass-actuator and controller, and the signal is received in the downhole MWD system using a sensor that is affected by either flow or pressure. In the second case, the surface rotary speed is controlled manually, and the signal is received using a sensor that is affected.

For uplink telemetry, a suitable pulser is described in U.S. Pat. No. 6,626,253 to Hahn et al., having the same assignee as the present application and the contents of which are fully incorporated herein by reference. Described in Hahn '253 is an anti-plugging oscillating shear valve system for generating pressure fluctuations in a flowing drilling fluid. The system includes a stationary stator and an oscillating rotor, both with axial flow passages. The rotor oscillates in close proximity to the stator, at least partially blocking the flow through the stator and generating oscillating pressure pulses. The rotor passes through two zero speed positions during each cycle, facilitating rapid changes in signal phase, frequency, and/or amplitude facilitating enhanced data encoding.

U.S. RE38,567 to Gruenhagen et al., having the same assignee as the present invention and the contents of which are fully incorporated herein by reference, and U.S. Pat. No. 5,113,379 to Scherbatskoy teach methods of downlink telemetry in which flow rate is controlled using a bypass-actuator and controller.

Drilling systems (described below) include mud pumps for conveying drilling fluid into the drillstring and the borehole. Pressure waves from surface mud pumps produce considerable amounts of noise. The pump noise is the result of the motion of the mud pump pistons. The pressure waves from the mud pumps travel in the opposite direction from the uplink telemetry signal. Components of the noise waves from the surface mud pumps may be present in the frequency range used for transmission of the uplink telemetry signal and may even have a higher level than the received uplink signal, making correct detection of the received uplink signal very difficult. Additional sources of noise include the drilling motor and drill bit interaction with the formation. All these factors degrade the quality of the received uplink signal and make it difficult to recover the transmitted information.

There have been numerous attempts to find solutions for reducing interfering effects in MWD telemetry signals. U.S. Pat. Nos. 3,747,059 and 3,716,830 to Garcia teach methods of reducing the effect of mud pump noise wave reflecting off the flexible hose; other reflections or distortions of the noise or signal waves are not addressed.

U.S. Pat. No. 3,742,443 to Foster et al. teaches a noise reduction system that uses two spaced apart pressure sensors. The optimum spacing of the sensors is one-quarter wavelength at the frequency of the telemetry signal carrier. The signal from the sensor closer to the mud pumps is passed through a filter having characteristics related to the amplitude and phase distortion encountered by the mud pump noise component as it travels between the two spaced points. The filtered signal is delayed and then subtracted from the signal derived from the sensor further away from the mud pumps. The combining function leads to destructive interference of the mud pump noise and constructive interference of the telemetry signal wave, because of the one-quarter wavelength separation between the sensors. The combined output is then passed through another filter to reduce distortion introduced by the signal processing and combining operation. The system does not account for distortion introduced in the telemetry signal wave as it travels through the mud column from the downhole transmitter to the surface sensors. The filter on the combined output also assumes that the mud pump noise wave traveling from the mud pumps between the two sensors encounters the same distortion mechanisms as the telemetry signal wave traveling in the opposite direction between the same pair of sensors. This assumption does not, however, always hold true in actual MWD systems.

U.S. Pat. No. 4,262,343 to Claycomb discloses a system in which signals from a pressure sensor and a fluid velocity detector are combined to cancel mud pump noise and enhance the signal from downhole. U.S. Pat. No. 4,590,593 to Rodney discloses a two sensor noise canceling system similar to those of Garcia and Foster et al., but with a variable delay. The delay is determined using a least mean squares algorithm during the absence of downhole data transmission. U.S. Pat. No. 4,642,800 issued to Umeda discloses a noise-reduction scheme that includes obtaining an “average pump signature” by averaging over a certain number of pump cycles. The assumption is that the telemetry signal is not periodic with the same period as the pump noise and, hence, will average to zero. The pump signature is then subtracted from the incoming signal to leave a residual that should contain mostly telemetry signal. U.S. Pat. No. 5,146,433 to Kosmala et al. uses signals from position sensors on the mud pumps as inputs to a system that relates the mud pump pressure to the position of the pump pistons. Thus, the mud pump noise signature is predicted from the positions of the pump pistons. The predicted pump noise signature is subtracted from the received signal to cancel the pump noise component of the received signal.

U.S. Pat. No. 4,715,022 to Yeo discloses a signal detection method for mud pulse telemetry systems using a pressure transducer on the gas filled side of the pulsation dampener to improve detection of the telemetry wave in the presence of mud pump noise. One of the claims includes a second pressure transducer on the surface pipes between the dampener and the drill string and a signal conditioner to combine the signals from the two transducers. Yeo does not describe how the two signals may be combined to improve signal detection.

U.S. Pat. No. 4,692,911 to Scherbatskoy discloses a scheme for reducing mud pump noise by subtracting from the received signal, the signal that was received T seconds previously, where T is the period of the pump strokes. The received signal comes from a single transducer. A delay line is used to store the previous noise pulse from the mud pumps and this is then subtracted from the current mud pump noise pulse. This forms a comb filter with notches at integer multiples of the pump stroke rate. The period T of the mud pumps may be determined from the harmonics of the mud pump noise, or from sensors placed on or near the mud pumps. The telemetry signal then needs to be recovered from the output of the subtraction operation (which includes the telemetry signal plus delayed copies of the telemetry signal).

U.S. Pat. No. 5,969,638 to Chin discloses a signal processor for use with MWD systems. The signal processor combines signals from a plurality of signal receivers on the standpipe, spaced less than one-quarter wavelength apart to reduce mud pump noise and reflections traveling in a downhole direction. The signal processor isolates the derivative of the forward traveling wave, i.e., the wave traveling up the drill string, by taking time and spatial derivatives of the wave equation. Demodulation is then based on the derivative of the forward traveling wave. The signal processor requires that the signal receivers be spaced a distance of five to fifteen percent of a typical wavelength apart.

All the aforementioned prior art systems are attempting to find a successful solution that would eliminate a substantial portion or all of the mud pump noise measured by transducers at the surface and, in so doing, improve reception of telemetry signals transmitted from downhole. Some of these systems also attempt to account for reflected waves traveling back in the direction of the source of the original waves. However, none provide means for substantially reducing mud pump noise while also dealing with distortion of the telemetry signal, caused by the mud channel and reflected waves, frequency selectivity of the sensors, the pulser and pump noise cancellation systems.

GB 2361789 to Tennent et al. teaches a receiver and a method of using the receiver for use with a mud-pulse telemetry system. The receiver comprises at least one instrument for detecting and generating signals in response to a telemetry wave and a noise wave traveling opposite the telemetry wave, the generated signals each having a telemetry wave component and a noise wave component. A filter receives and combines the signals generated by the instruments to produce an output signal in which the noise wave component is filtered out. An equalizer reduces distortion of the telemetry wave component of the signals. The teachings of Tennent include correcting for a plurality of reflectors that, in combination with the uplink and mud pump signals, affect that received signals. In essence, Tennent determines a transfer function for the mud channel in both directions. Determination of these transfer functions is difficult when both the mud pump and the downhole pulser are operating. The present invention addresses this difficulty with a simple solution. In practical digital communication systems that are designed to transmit at high speed through band-limited channels, the frequency response of the channel is not known. The channel distortion results in intersymbol interference, which, if left uncompensated, causes high error rates. The compensator for the intersymbol interference is called an equalizer

### SUMMARY OF THE INVENTION

One embodiment of the present invention is a method of communicating a signal through a fluid in a borehole between a downhole location and a surface location. Signals are measured at or near the surface in response to operation of a message source at the downhole location. A transfer function of the channel between the source and the surface is determined. The determination of the channel transfer function may be based on measurements responsive to a reference signal such as a chirp signal generated at the source. Once the transfer function has been estimated, it is used to recover, using an equalization method, an estimate of a message signal sent by the source. The equalizer may be implemented as transversal filter or as an infinite impulse response (IIR) filter. Its filter coefficients may be estimated from the channel transfer function or directly from the received reference signal, minimizing a cost function depending on the reference signal and the received reference signal. This may be done using zero-forcing-algorithm or a LMS algorithm. The equalizer may be an adaptive one to cope with changing channel characteristics. Equalization may be applied before or after demodulation.

In another embodiment of the present invention a feedback transversal filter may be used as equalizer. The feedback equalizer may be an adaptive one based on a blind algorithm or may be initialized using training signals. The feedback equalizer may use a stochastic gradient algorithm e.g. a signed or an unsigned constant modulus algorithm (CMA), or a hybrid of a signed and unsigned CMA.

In another embodiment of the present invention the transversal filter and the feedback transversal filter may be used together as decision feedback equalizer. The transversal filter serves as feedforward filter located before or after the demodulator and the filter from [0018] serves as feedback filter.

Another embodiment of the invention is a system for communicating a signal through a fluid in a borehole between a bottomhole assembly (BHA) and a surface location. The system includes a message source on the bottomhole assembly (BHA) capable of generating a message signal. The source sends signals through the mud channel that are received at the surface. Based on the received signals, a processor estimates an equalization filter undoing the effects of the transfer function of the mud channel. In one embodiment of the invention, the equalization filter estimation is based on transmission of a chirp signal by the source. The processor then can obtain an equalized estimate of other signals sent by the source. The processor may implement a feedback equalizer that is used to remove part of the inter-symbol interference that remains after the forward equalization. The feedback equalizer may be an adaptive one based on a blind algorithm or may be derived using a training sequence. The feedback equalizer may use a stochastic gradient algorithm e.g. a signed or an unsigned constant modulus algorithm (CMA), or a hybrid of a signed and unsigned CMA.

Another embodiment of the invention is a machine readable medium for use in conjunction with a bottomhole assembly (BHA) conveyed in a borehole in an earth formation. The medium includes instructions which enable a processor to estimate a transfer function of a mud channel between a downhole signal source and a surface detector based on a reference signal sent by the source. The medium further includes instructions which enable the processor to recover, using a feedback equalization technique, another signal sent by the source. The machine readable medium may be a ROM, an EPROM, an EAROM, a Flash Memory, and/or an Optical disk. The medium may include instructions for generating the message signal in response to a measurement of a parameter of the BHA and/or a measurement of a property of the earth formation.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 (prior art) is a schematic illustration of a drilling system suitable for use with the present invention;

FIGS. 2a-2c (prior art) is a schematic of an oscillating shear valve suitable for use with the present invention;

FIG. 3 is a flow chart of the processing used on signals received at a surface location;

FIG. 4 is an illustration of model for signal propagation at surface;

FIG. 5 shows a decision feedback equalizer structure used for surface signal processing;

FIG. 6 shows the concept of applying an equalizer;

FIG. 7 illustrates the methodology of adaptive equalization processing; and

FIG. 8 shows a flow chart of an adaptive feedback equalizer.

### DETAILED DESCRIPTION OF THE INVENTION

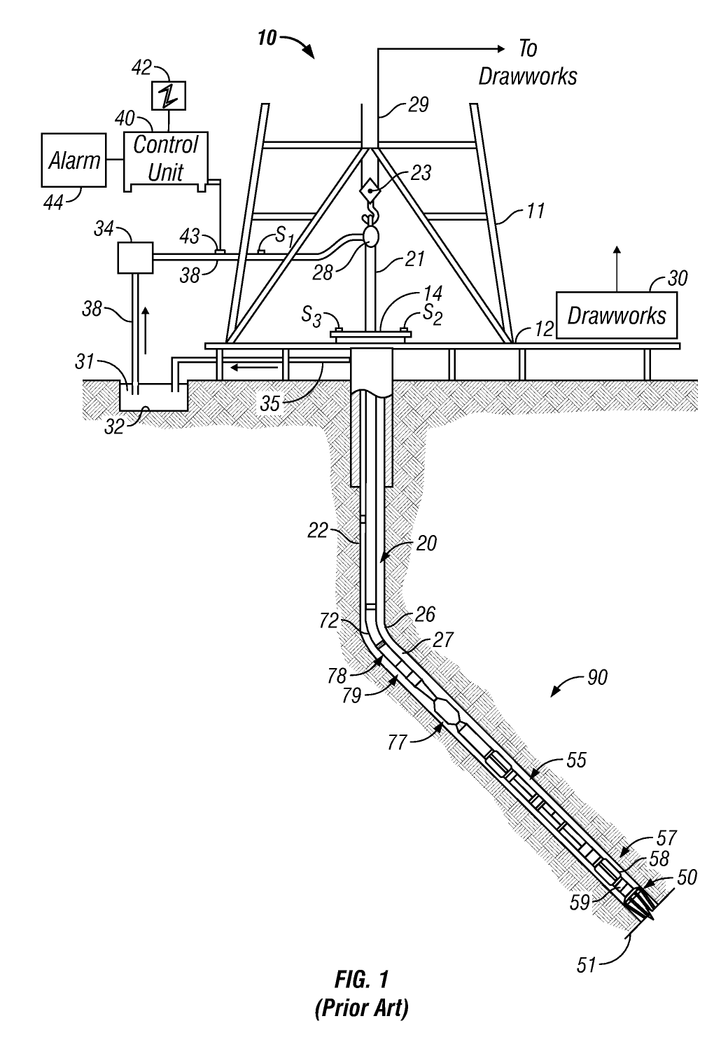

FIG. 1 shows a schematic diagram of a drilling system 10 with a drillstring 20 carrying a drilling assembly 90 (also referred to as the bottom hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ typically placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In an exemplary embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters typically include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur. The system also includes a downhole processor, sensor assembly for making formation evaluation and an orientation sensor. These may be located at any suitable position on the bottomhole assembly (BHA).

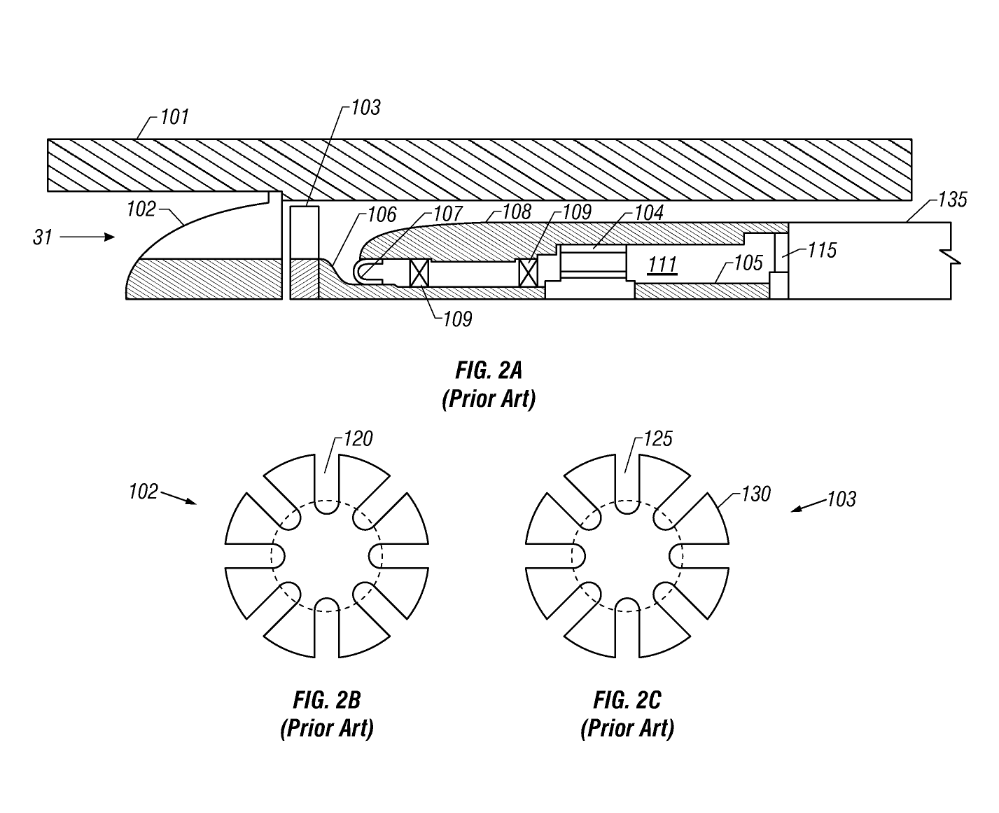

FIG. 2a is a schematic view of the pulser, also called an oscillating shear valve, assembly 19, for mud pulse telemetry. The pulser assembly 19 is located in the inner bore of the tool housing 101. The housing 101 may be a bored drill collar in the bottom hole assembly 10, or, alternatively, a separate housing adapted to fit into a drill collar bore. The drilling fluid 31 flows through the stator 102 and rotor 103 and passes through the annulus between the pulser housing 108 and the inner diameter of the tool housing 101.

The stator 102, see FIGS. 2a and 2b, is fixed with respect to the tool housing 101 and to the pulser housing 108 and has multiple lengthwise flow passages 120. The rotor 103, see FIGS. 2a and 2c, is disk shaped with notched blades 130 creating flow passages 125 similar in size and shape to the flow passages 120 in the stator 102. Alternatively, the flow passages 120 and 125 may be holes through the stator 102 and the rotor 103, respectively. The rotor passages 125 are adapted such that they can be aligned, at one angular position with the stator passages 120 to create a straight through flow path. The rotor 103 is positioned in close proximity to the stator 102 and is adapted to rotationally oscillate. An angular displacement of the rotor 103 with respect to the stator 102 changes the effective flow area creating pressure fluctuations in the circulated mud column. To achieve one pressure cycle it is necessary to open and close the flow channel by changing the angular positioning of the rotor blades 130 with respect to the stator flow passage 120. This can be done with an oscillating movement of the rotor 103. Rotor blades 130 are rotated in a first direction until the flow area is fully or partly restricted. This creates a pressure increase. They are then rotated in the opposite direction to open the flow path again. This creates a pressure decrease. The required angular displacement depends on the design of the rotor 103 and stator 102. The more flow paths the rotor 103 incorporates, the less the angular displacement required to create a pressure fluctuation is. A small actuation angle to create the pressure drop is desirable. The power required to accelerate the rotor 103 is proportional to the angular displacement. The lower the angular displacement is, the lower the required actuation power to accelerate or decelerate the rotor 103 is. As an example, with eight flow openings on the rotor 103 and on the stator 102, an angular displacement of approximately 22.5° is used to create the pressure drop. This keeps the actuation energy relatively small at high pulse frequencies. Note that it is not necessary to completely block the flow to create a pressure pulse and therefore different amounts of blockage, or angular rotation, create different pulse amplitudes.

The rotor 103 is attached to shaft 106. Shaft 106 passes through a flexible bellows 107 and fits through bearings 109 which fix the shaft in radial and axial location with respect to housing 108. The shaft is connected to a electrical motor 104, which may be a reversible brushless DC motor, a servomotor, or a stepper motor. The motor 104 is electronically controlled, by circuitry in the electronics module 135, to allow the rotor 103 to be precisely driven in either direction. The precise control of the rotor 103 position provides for specific shaping of the generated pressure pulse. Such motors are commercially available and are not discussed further. The electronics module 135 may contain a programmable processor which can be preprogrammed to transmit data utilizing any of a number of encoding schemes which include, but are not limited to, Amplitude Shift Keying (ASK), Frequency Shift Keying (FSK), or Phase Shift Keying (PSK), continuous phase modulation (CPM) or a combination of these techniques.

In one embodiment of the invention, the tool housing 101 has pressure sensors, not shown, mounted in locations above and below the pulser assembly, with the sensing surface exposed to the fluid in the drill string bore. These sensors are powered by the electronics module 135 and can be for receiving surface transmitted pressure pulses. The processor in the electronics module 135 may be programmed to alter the data encoding parameters based on surface transmitted pulses. The encoding parameters can include type of encoding scheme, baseline pulse amplitude, baseline frequency, or other parameters affecting the encoding of data.

The entire pulser housing 108 is filled with appropriate lubricant 111 to lubricate the bearings 109 and to pressure compensate the internal pulser housing 108 pressure with the downhole pressure of the drilling mud 31. The bearings 109 are typical anti-friction bearings known in the art and are not described further. In one embodiment, the seal 107 is a flexible bellows seal directly coupled to the shaft 106 and the pulser housing 108 and hermetically seals the oil filled pulser housing 108. The angular movement of the shaft 106 causes the flexible material of the bellows seal 107 to twist thereby accommodating the angular motion. The flexible bellows material may be an elastomeric material or, alternatively, a fiber reinforced elastomeric material. It is necessary to keep the angular rotation relatively small so that the bellows material will not be overstressed by the twisting motion. In an alternate preferred embodiment, the seal 107 may be an elastomeric rotating shaft seal or a mechanical face seal.

In one embodiment, the motor 104 is adapted with a double ended shaft or alternatively a hollow shaft. One end of the motor shaft is attached to shaft 106 and the other end of the motor shaft is attached to torsion spring 105. The other end of torsion spring 105 is anchored to end cap 115. The torsion spring 105 along with the shaft 106 and the rotor 103 comprise a mechanical spring-mass system. The torsion spring 105 is designed such that this spring-mass system is at its natural frequency at, or near, the desired oscillating pulse frequency of the pulser. The methodology for designing a resonant torsion spring-mass system is well known in the mechanical arts and is not described here. The advantage of a resonant system is that once the system is at resonance, the motor only has to provide power to overcome external forces and system dampening, while the rotational inertia forces are balanced out by the resonating system.

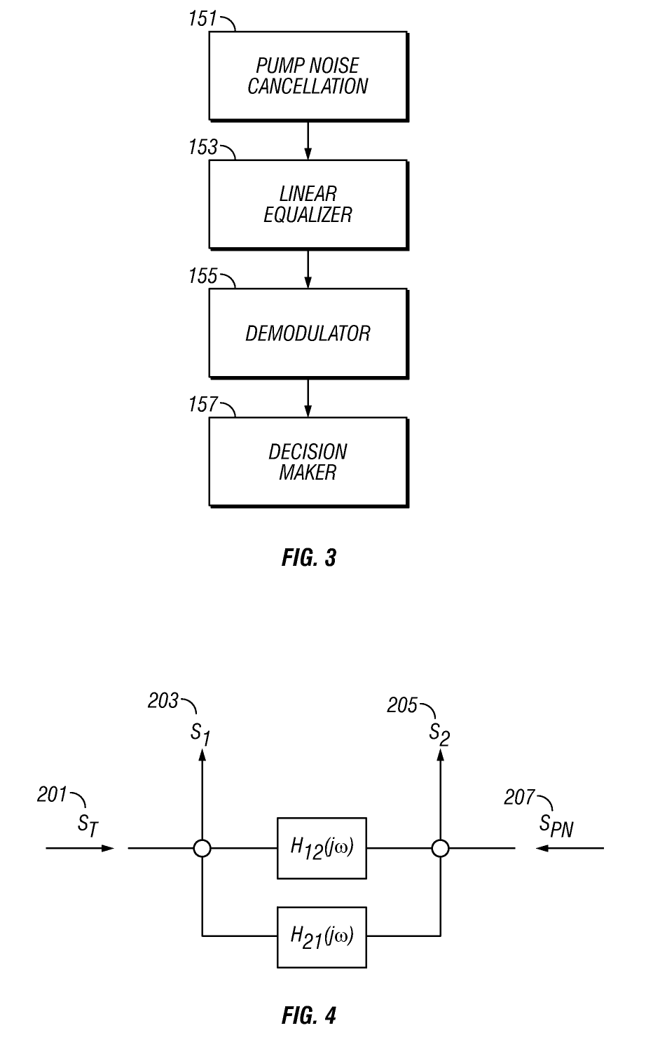

Turning now to FIG. 3, some of the processing steps involved in processing of signal received at the surface r₍ₙ₎ are illustrated. At 151, the pump noise cancellation (PNC) is done. This may be done using the method described in U.S. patent application Ser. No. 11/311,196 of Reckmann et al., having the same assignee as the present application and the contents of which are incorporated herein by reference. Other methods known in the art may be used. Included in the pump noise cancellation, or separate from it may be a channel estimation step in which the transfer function of the mud channel between the downhole source and the surface detectors is determined. An adaptive equalization filter 153 is implemented as a finite impulse response (FIR) filter. Its coefficients are estimated by evaluating the differences of a reference signal and its corrupted received signal, e.g. chirp. The equalization filter may also be implemented as an infinite impulse response (IIR) filter. The use of chirp signals for evaluation of the channel transfer function and equalization is discussed in detail in an application filed concurrently with the present application under Attorney Docket No. 564-42779 having as inventors Reckmann and Wassermann. As discussed therein, chirps are regularly inserted to continuously track changes of the channel characteristics. The output \hat{r}₍ₙ₎ of a demodulator 155 is fed to a decision maker 157, the output Î₍ₙ₎ of which is the recovered telemetry signal.

Turning now to FIG. 4, a block diagram showing the propagation of signals is shown. Denoted by 201 and 207 are the telemetry (message) signal ST and the pump noise s_{PN}. The signals are detected by two sensors s₁ and s₂ (203, 205 respectively). The mixture of the telemetry signal s_{T} and pump noise s_{PN}, both signal waves traveling in opposite direction through the system with the transfer functions H₁₂(jω) and H₂₁(jω) for each direction, will be measured by two sensors as

s₁(t)=s_{T}+F⁻¹(H₂₁(jω))*s_{PN},

s₂(t)=s_{PN}+F⁻¹(H₁₂(jω))*s_{T} (1)

where F⁻¹ is the inverse Fourier transform and * is the convolution operator. In a first step the transfer function between these two sensors is evaluated in the absence of any telemetry signals s_{T}(ΔT)=0 in a time interval ΔT. The complex transfer function I₂₁(jω) can be generated by Fourier transforming the signals s₁(ΔT), s₂(ΔT) and a division:

$${I}_{21} ( jω ) = \frac{F ( {s}_{1} ( Δ T ) )}{F ( {s}_{2} ( Δ T ) )} = {H}_{21} ( jω ) . \qquad ( 2 )$$

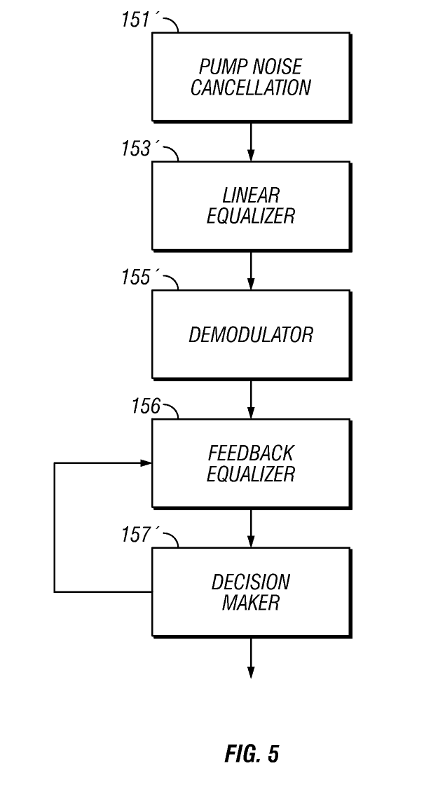

To undo signal distortions from the channel, noise cancellation, reflections and other sources of frequency selectivity, the present invention incorporates a decision feedback equalizer. FIG. 5 is a flow chart illustrating a possible integration of the feedback equalizer in the signal processing of signals received at the surface. Other possible implementations are the linear equalizer 153 missing or located after the demodulator 155′. This is similar to FIG. 3 but with the addition of a second equalizer 156 between the demodulator 155′ and the decision maker 157′. The decision made on the equalized signal is fed back to the feedback equalizer for adapting the latter. Functionally, the feedback equalizer is used to remove that part of the inter-symbol interference that remains after forward equalization if a forward equalizer 153′ is implemented.

A linear equalizer with the same structure may be used for the forward equalizer as well as the feedback equalizer. The linear equalizer can be implemented either as a symbol-spaced or fractionally-spaced filter. If the linear equalizer 153′ is located before the demodulator it operates on modulated signals, hence a fractionally spaced implementation is used to satisfy the Nyquist criterion. As known in the art, fractionally-spaced feedback equalizer implementations are much more powerful than symbol-spaced implementations.

At first, we assume that a feedback equalizer is used, with coefficients of the equalizer denoted by c₍ₙ₎. Then, the convolution of the channel impulse response with the equalizer response can be expressed as:

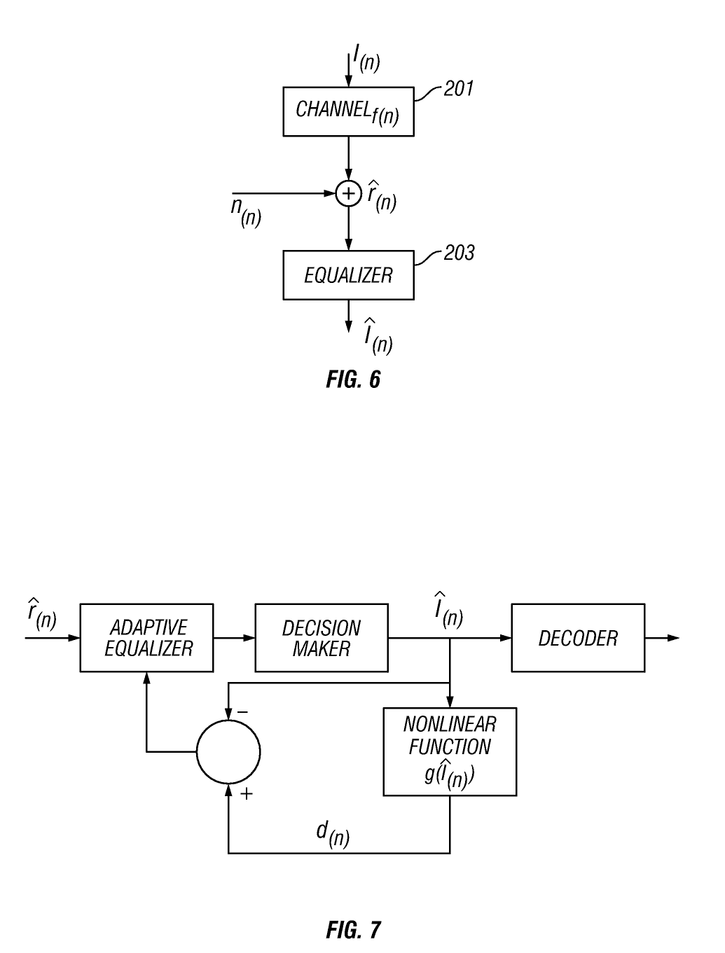

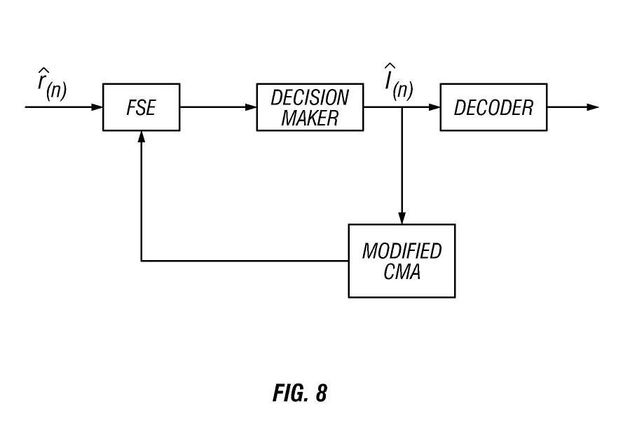

c₍ₙ₎*f₍ₙ₎=δ₍ₙ₎+e₍ₙ₎ (3),

where * represents a convolution operation. We interpret the channel impulse response f₍ₙ₎ as complete system from the modulator to demodulator; including PNC, linear forward equalizer and demodulator as shown in FIG. 5. δ₍ₙ₎ is the unit sample sequence and e₍ₙ₎ denotes the error sequence that results from our initial equalizer. A corresponding general receiver is depicted in FIG. 6 where I₍ₙ₎ is the signal to be transmitted through channel 201 Î₍ₙ₎ is the reconstructed signal at the output of the equalizer 203 receiver, \hat{r}₍ₙ₎ is the input signal to the equalizer and η₍ₙ₎ is the additive noise.

\hat{r}₍ₙ₎=I₍ₙ₎*f₍ₙ₎+η₍ₙ₎ (4).

### If we convolve the equalizer response with the received signal \hat{r}₍ₙ₎, we obtain

Î₍ₙ₎=\hat{r}₍ₙ₎*c₍ₙ₎ (5).

### We replace \hat{r}₍ₙ₎ and get the estimate Î₍ₙ₎ of the transmitted signal

$$\begin{matrix}{\hat{I}}_{( n )} = {I}_{( n )} * {f}_{( n )} * {c}_{( n )} + {η}_{( n )} * {c}_{( n )} \\ = {I}_{( n )} * ( {δ}_{( n )} + {e}_{( n )} ) + {η}_{( n )} * {c}_{( n )} \\ = {I}_{( n )} + {I}_{( n )} * {e}_{( n )} + {η}_{( n )} * {c}_{( n )} .\end{matrix} \qquad ( 6 )$$

In this equation, the term I₍ₙ₎ represents the transmitted sequence, the term I₍ₙ₎*e₍ₙ₎ represents the residual inter-symbol interference (ISI) and the term η₍ₙ₎*c₍ₙ₎ represents the additive noise. Our equalizing objective is to find the best estimate of a desired response denoted by d₍ₙ₎. This process can be interpreted as minimizing the ISI term and an additive noise term. In one embodiment of the present invention we use a stochastic gradient algorithm to generate the desired response d₍ₙ₎. The mean square error (MSE) criterion may be employed to determine the best estimation of I₍ₙ₎ from the observed equalizer output I₍ₙ₎. In general, the best estimate d₍ₙ₎ is given by d₍ₙ₎=g(Î₍ₙ₎), where g(Î₍ₙ₎) is a non-linear function. The non-linear function g(Î₍ₙ₎) is given by the used algorithm which can be chosen, for example, from the following: Godard algorithm, also known as constant-modulus algorithm, Sato algorithm, Benveniste-Goursat algorithm or Stop-and-go algorithm, as known in the art. The sequence d₍ₙ₎ is then used to generate an error signal ε₍ₙ₎, which is fed back into the adaptive equalizer filter, as shown in FIG. 7. The error signal is used to update the equalizer coefficients.

In one embodiment of the invention, a training sequence is provided. In the case of adaptive equalization using a training sequence, the desired sequence equals the transmitted sequence, d₍ₙ₎=I₍ₙ₎ and we do not need to use. g(Î₍ₙ₎) to generate a desired response.

One embodiment of the invention uses the CMA. Constant modulus algorithms are based on the MSE criterion and the LMS Gradient Algorithm. The error signal of the symbol I₍ₖ₎ at time k is the difference between the detected symbol Î₍ₖ₎ and the transmitted symbol I₍ₖ₎. It can be expressed as

ε₍ₖ₎=I₍ₖ₎−Î₍ₖ₎ (7).

### The resulting p^{th} order cost function J is

J=E{(|Î₍ₖ₎|^{p}|I₍ₖ₎|^{p})²} (8).

### Minimizing the cost function leads us to use the LMS algorithm, which is based on the knowledge of the transmitted sequence, for recursively estimating C₍ₖ₎. This can be described as

C₍ₖ₊₁₎=C₍ₖ₎−μ(Î₍ₖ₎−I₍ₖ₎)\hat{R}₍ₖ₎ (9),

where μ is the step size parameter for recursive iterations of the equation. Unfortunately, the transmitted sequence is unknown. However, we have a fair amount of knowledge on its statistics that we can use. For this, Godard proposed an approach by selecting a more general cost function, called the dispersion of order p, defined as

D=E{(|Î₍ₖ₎|^{p}−γₚ)²} (10),

where γₚ is a positive real constant representing the p^{th} order expectation of I₍ₖ₎. It additionally controls the equalizer amplification. In case of perfect equalization, we expect a zero mean square error. The gradient of the dispersion of order p is zero for γₚ given by

$${γ}_{p} = \frac{E ( {\vert {I}_{( k )} \vert}^{2 p} )}{E ( {\vert {I}_{( k )} \vert}^{p} )} . \qquad ( 11 )$$

One embodiment of the invention uses the case p=2, which leads to the relatively simple Constant Modulus Algorithm, where we have:

$${γ}_{2} = \frac{E ( {\vert {I}_{( k )} \vert}^{4} )}{E ( {\vert {I}_{( k )} \vert}^{2} )} . \qquad ( 12 )$$

Since the expectation of I₍ₖ₎ depends on the received signal energy, we do not generally know γ₂. Furthermore, it depends on the used type of demodulation. The main modulation scheme used in our MPT system is binary PSK. If we normalize the received signal by its standard deviation we get γ₂=1.

In one embodiment of the invention the Godard algorithm is used. The CMA filter coefficients may be updated utilizing LMS techniques by:

C₍ₖ₊₁₎=C₍ₖ₎−μΨ₍ₖ₎\hat{R}₍ₖ₎ (14),

where μ is the step size parameter or the convergence factor, which defines the convergence speed of the algorithm. \hat{R}₍ₖ₎ is the received signal in vector form and Ψ₍ₖ₎ is the error function:

Ψ₍ₖ₎=Î₍ₖ₎(|Î₍ₖ₎|²−γ₂) (13).

In one embodiment of the invention, an Unsigned CMA is used. The error function may be described as:

Ψ₍ₖ₎=Î₍ₖ₎(|Î₍ₖ₎|²−γ₂) (15).

Ψ₍ₖ₎ consists of the equalized output term Î₍ₖ₎ and an amplitude correction term (|Î₍ₖ₎|²−γ₂). This last term is used to correct the symbol around the Î₍ₖ₎ to slowly reach the desired value γ₂.

Another embodiment of the invention uses a more computationally efficient algorithm using signed-error. It modifies the equalizer update equation of the unsigned algorithm by retaining only the sign of the error function, thereby eliminating a multiplication operation:

Ψ₍ₖ₎=sign(Î₍ₖ₎(|Î₍ₖ₎|²−γ₂)) (16).

The signed error constant modulus algorithm (SE-CMA) is useful for signed error correction. However, since it neglects amplitude correction it tends to cause instable operations.

To equalize the signal, we simply convolve the equalizer coefficients with received signals.

$${\hat{I}}_{( k )} = {\sum }_{n = - K}^{K} {c}_{( n )} {\hat{r}}_{( k - n )} \qquad ( 18 )$$

### The corresponding vector form is

Î₍ₖ₎=\hat{R}₍ₖ₎^{T}C₍ₖ₎

where C₍ₖ₎ is the estimated equalization coefficients vector C₍ₖ₎=[c_{-K} . . . c₀ . . . c_{+K}]^{T} and \hat{R}₍ₖ₎ is the received signal \hat{R}₍ₖ₎[\hat{r}_{k-K} . . . \hat{r}ₖ . . . \hat{r}_{k+K}]^{T}.

The operation of the transmitter and receivers may be controlled by the downhole processor and/or the surface processor. The processing of the surface data is carried out by a surface processor. Implicit in the control and processing of the data is the use of a computer program on a suitable machine readable medium that enables the processor to perform the control and processing. The machine readable medium may include ROMs, EPROMs, EAROMs, Flash Memories and Optical disks.

This invention may be better understood using the following acronyms and definitions

### ASK: Amplitude shift keying;

### BHA; Bottomhole assembly;

### CMA: Constant modulus algorithm;

### CPM: Continuous phase modulation

### Equalization: the process of reducing amplitude and/or phase distortion;

### FIR filter—a filter having a Finite impulse response, also called transversal filter;

### FSK: Frequency shift keying;

IIR filter: a recursive filter structure with an infinite impulse response;

### LMS Least means squares;

### MPT: Mud pulse telemetry

### PNC: Pump noise cancellation;

### PSK: phase shift keying;

The foregoing description is directed to particular embodiments of the present invention for the purpose of illustration and explanation. It will be apparent, however, to one skilled in the art that many modifications and changes to the embodiment set forth above are possible without departing from the scope of the invention. It is intended that the following claims be interpreted to embrace all such modifications and changes.

What is claimed is:

1. A method of communicating a signal through a fluid in a borehole between a downhole source location and a surface location, the method comprising:
(a) generating a message signal at the downhole location and receiving a first signal at the surface location responsive to the message signal;
(b) determining a transfer function between the downhole location and a surface location; and
(c) using the determined transfer function and an equalization method including a feedback equalizer for providing an estimate of the message signal.

2. The method of claim 1 further comprising determining the transfer function by:
(i) generating a reference signal at the downhole location;
(ii) making an additional measurement at the surface location responsive to the reference signal; and
(iii) determining from the additional measurement and the reference signal the transfer function.

3. The method of claim 2 wherein the reference signal comprises a chirp signal.

4. The method of claim 3 wherein the equalization method further comprises using a filter selected from the group consisting of: (i) a finite impulse response (FIR) filter, and (ii) and infinite impulse response (IIR) filter.

5. The method of claim 4 further comprising estimating coefficients of the filter by:
(i) generating a reference signal at the downhole location;
(ii) measuring an additional signal at the surface location responsive to the reference signal; and
(iii) minimizing a cost function based on the reference signal and the additional signal.

6. The method of claim 1 wherein providing the estimated message signal further comprises a demodulation.

7. The method of claim 6 wherein the demodulation is subsequent to the equalization.

8. The method of claim 7 further comprising an additional equalization subsequent to the demodulation.

9. The method of claim 8 wherein the additional equalization further comprises a feedback equalization.

10. The method of claim 1 wherein the equalization method further comprises using a stochastic gradient algorithm.

11. The method of claim 1 wherein the equalization method further comprises using at least one of: (i) a Godard algorithm, (ii) a Sato algorithm, (iii) a Benveniste-Goursat algorithm, and (iv) a Stop-and-go algorithm.

12. The method of claim 1 further comprising displaying an estimate of the property at the surface location.

13. The method of claim 1 wherein the message signal is indicative of at least one of (i) an operating condition of a bottomhole assembly, and (ii) a location and orientation of the borehole.

14. An apparatus for evaluating an earth formation, the apparatus comprising:
(a) a formation evaluation sensor configured to be conveyed in a borehole and make a measurement indicative of the property of the earth formation;
(b) a message source configured to generate a message signal in a borehole fluid at a downhole location;
(c) a sensor at a surface location configured to receive a first signal responsive to the message signal; and
(d) a processor configured to:
(A) determine a transfer function between the downhole location and a surface location; and
(B) use the determined transfer function and an equalization method including a feedback equalizer for providing an estimate of the message signal.

15. The apparatus of claim 14 wherein the message source is further configured to generate a reference signal; and processor is further configured to determine the transfer function by using the reference signal and an additional measurement at the surface location responsive to the reference signal.

16. The apparatus of claim 15 wherein the reference signal comprises a chirp signal.

17. The apparatus of claim 14 wherein the equalizer further comprises at least one of: (i) a finite impulse response (FIR) filter, and (ii) an infinite impulse response (IIR) filter.

18. The apparatus of claim 14 wherein the processor is further configured to provide the estimated message signal by using a demodulation.

19. The apparatus of claim 18 wherein the processor is configured to apply the demodulation subsequent to the equalization.

20. The apparatus of claim 19 wherein the processor is further configured to apply an additional equalization subsequent to the demodulation.

21. The apparatus of claim 14 further comprising a bottomhole assembly conveyed on a drilling tubular; the bottomhole assembly including the formation evaluation sensor and the message source.

22. The apparatus of claim 14 wherein the processor is further configured to display an estimate of the property at the surface location.

23. The apparatus of claim 14 wherein the message signal is indicative of at least one of: (i) an operating condition of a bottomhole assembly, and (ii) a location and orientation of the borehole the apparatus further comprising a sensor configured to measure the at least one of (i) an operating condition of a bottomhole assembly, and (ii) a location and orientation of the borehole.
